(19) United States
(12) Patent Application Publication
(10) Pub. No.: US 2026/0108851 A1
(43) Pub. Date: Apr. 23, 2026

(54) POLYELECTROLYTE COACERVATE MEMBRANES AND METHODS FOR THE MANUFACTURE THEREOF

(71) Applicant: University of Massachusetts, Westborough, MA (US)

(72) Inventors: Jessica Schiffman, Amherst, MA (US); Shao-Hsiang Hung, Amherst, MA (US); Brennan Finbar Coleman, Northampton, MA (US)

(21) Appl. No.: 19/363,234

(22) Filed: Oct. 20, 2025

Related U.S. Application Data
(60) Provisional application No. 63/710,693, filed on Oct. 23, 2024.

(51) Int. Cl. B01D 67/00; B01D 61/02; B01D 69/02; B01D 71/28; B01D 71/62

(52) U.S. Cl. CPC B01D 67/0016; B01D 61/025; B01D 67/0011; B01D 67/0083; B01D 69/02; B01D 71/281; B01D 71/62; B01D 2325/0231; B01D 2325/04; B01D 2325/20; B01D 2325/26; B01D 2325/30

(57) ABSTRACT

Methods for the manufacture of a polyelectrolyte coacervate membrane are provided. In an aspect, the method includes providing a polyelectrolyte coacervate phase. The polyelectrolyte coacervate phase includes a polyanion, a polycation, water, and a salt. The polyelectrolyte coacervate phase is coated onto a substrate, and the coated substrate is immersed in a coagulation bath to provide a polyelectrolyte coacervate membrane. The polyelectrolyte coacervate membrane can be annealed. Polyelectrolyte coacervate membranes made by the method are also described.

### CROSS-REFERENCE TO RELATED APPLICATION

This application claims priority to U.S. Provisional Application No. 63/710,693, filed Oct. 23, 2024, the contents of which are hereby incorporated by reference in their entirety.

### FEDERAL RESEARCH STATEMENT

This invention was made with government support under Grant No. 2227307 awarded by the National Science Foundation. The government has certain rights in the invention.

### BACKGROUND

According to the World Health Organization, in 2021, over 2 billion people were living in water-stressed countries. Access to clean water will remain a major challenge for the foreseeable future due to climate change and population growth, which will further exacerbate this problem. Currently, membrane-based reverse osmosis (RO) processes are the most reliable method of producing clean water through desalination. Since its invention in the 1960s, non-solvent induced phase separation (NIPS) has been an industry workhorse for fabricating asymmetric polymeric membranes for filtration applications, ranging from RO to dialysis.

It would be advantageous to provide improved processes for manufacturing membranes for reverse osmosis. It would be particularly advantageous for such a process to eliminate the use of toxic organic solvents.

### SUMMARY

An aspect of the present disclosure is a method for the manufacture of a polyelectrolyte coacervate membrane, the method comprising: providing a polyelectrolyte coacervate phase comprising a polyanion, a polycation, water, and a salt; coating the polyelectrolyte coacervate phase onto a substrate to provide a coated substrate; immersing the coated substrate in a coagulation bath to provide a polyelectrolyte coacervate membrane; and annealing the polyelectrolyte coacervate membrane to provide an annealed polyelectrolyte coacervate membrane.

Another aspect of the present disclosure is a polyelectrolyte coacervate membrane made by the method described herein.

Another aspect is a polyelectrolyte coacervate membrane comprising a complexed polyanion and polycation.

Another aspect is a method of purifying a liquid feed stream, the method comprising: passing the liquid feed stream through the polyelectrolyte coacervate membrane to provide a purified liquid feed stream; wherein the liquid feed stream comprises at least one compound to be removed in a first concentration; and wherein the purified liquid feed stream comprising the compound to be removed in a second concentration that is less than the first concentration.

The above described and other features are exemplified by the following figures and detailed description.

### BRIEF DESCRIPTION OF THE DRAWINGS

The following figures are exemplary embodiments.

FIG. 1A shows top-down (top row), cross-sectional (middle row), and enlarged cross-sectional (bottom row) scanning electron micrographs (SEM) of PSS/PDADMAC membranes prepared from coacervate KBr concentration of 1.4 M in a 0.4 M KBr(aq) coagulation bath according to an aspect of the disclosure.

FIG. 1B shows top-down (top row), cross-sectional (middle row), and enlarged cross-sectional (bottom row) scanning electron micrographs (SEM) of PSS/PDADMAC membranes prepared from coacervate KBr concentration of 1.5 M in a 0.4 M KBr(aq) coagulation bath according to an aspect of the disclosure.

FIG. 1C shows top-down (top row), cross-sectional (middle row), and enlarged cross-sectional (bottom row) scanning electron micrographs (SEM) of PSS/PDADMAC membranes prepared from coacervate KBr concentration of 1.6 M in a 0.4 M KBr(aq) coagulation bath according to an aspect of the disclosure.

FIG. 2 shows wet thickness of the as-prepared PEC membranes prepared from varied coacervate KBr concentration (1.4, 1.5 and 1.6 M) in a 0.4 M KBr(aq) coagulation bath according to an aspect of the disclosure. Wet thickness includes the 135 μm thick non-woven substrate.

FIG. 3 shows pure water permeance of the as-prepared PEC membranes prepared from varied coacervate KBr concentration (1.4, 1.5 and 1.6 M) in a 0.4 M KBr(aq) coagulation bath according to an aspect of the disclosure.

FIG. 4A shows top-down (top row), cross-sectional (middle row), and enlarged cross-sectional (bottom row) SEM images of PSS/PDADMAC membranes prepared from 1.5 M KBr containing coacervates in coagulation bath KBr concentration of 0 (pure water).

FIG. 4B shows top-down (top row), cross-sectional (middle row), and enlarged cross-sectional (bottom row) SEM images of PSS/PDADMAC membranes prepared from 1.5 M KBr containing coacervates in coagulation bath KBr concentration of 0.2 M(aq).

FIG. 4C shows top-down (top row), cross-sectional (middle row), and enlarged cross-sectional (bottom row) SEM images of PSS/PDADMAC membranes prepared from 1.5 M KBr containing coacervates in coagulation bath KBr concentration of 0.4 M(aq).

FIG. 5 shows wet thickness of the PSS/PDADMAC membranes prepared from 1.5 M KBr containing coacervate in varied coagulation bath KBr concentration (0 (pure water), 0.2 and 0.4 M(aq)). Wet thickness includes the 135 μm thick non-woven substrate.

FIG. 6 shows pure water permeance of the PSS/PDADMAC membranes prepared from 1.5 M KBr containing coacervate in varied coagulation bath KBr concentration (0 (pure water), 0.2 and 0.4 M(aq)).

FIG. 7 shows top-down (top), cross-section (middle), and enlarged cross-sectional (bottom) SEM images of the 1.5/0.4 membrane structure annealed in 1.6 M NaCl(aq) solution.

FIG. 8 shows wet thickness of the membranes before and after salt annealing.

FIG. 9 shows pure water permeance of the membranes before and after salt annealing. The pure water permeance of the Sartorius control membrane is displayed using a red symbol; n.s. indicates that the samples are not statistically different.

FIG. 10 shows UV-vis spectra of the feed solution (black) containing 50 ppm each of methyl orange (MO) and methylene blue (MB). The spectra are provided of the permeate from 1.5/0.4 (light blue), annealed (dark blue) and control (red) membranes. Digital images show that the feed and 1.5/0.4 permeate solution color changes.

FIG. 11 shows MO and MB dye rejection percentages for 1.5/0.4, annealed and control membranes.

FIG. 12A shows single-component adsorption results showing the MO removal percentage as a function of time in the presence of 1.5/0.4, annealed and control membranes.

FIG. 12B shows single-component adsorption results showing the MO removal percentage as a function of time in the presence of 1.5/0.4, annealed and control membranes

FIG. 12C shows single-component adsorption results showing the MB removal percentage as a function of time in the presence of 1.5/0.4, annealed and control membranes.

FIG. 12D shows single-component adsorption results showing the MB removal percentage as a function of time in the presence of 1.5/0.4, annealed and control membranes.

FIG. 13 shows E. coli area coverage of glass, 1.5/0.4, annealed and control membranes after 24 hours of incubation at 37° C. Error bars denote standard errors. Two asterisks (**) denote that the values are significantly different at the 0.01 level, whereas n.s. indicates that the samples are not statistically different.

FIG. 14 shows representative atomic force microscopy (AFM) height profile images of control, 1.5/0.4 and annealed membranes.

FIG. 15A shows cross-sectional SEM micrographs of PSS/PDADMAC membranes fabricated at a stoichiometric ratio of 0.74.

FIG. 15B shows cross-sectional SEM micrographs of PSS/PDADMAC membranes fabricated at a stoichiometric ratio of 0.87.

FIG. 15C shows cross-sectional SEM micrographs of PSS/PDADMAC membranes fabricated at a stoichiometric ratio of 1.00.

FIG. 15D shows cross-sectional SEM micrographs of PSS/PDADMAC membranes fabricated at a stoichiometric ratio of 1.05.

FIG. 15E shows cross-sectional SEM micrographs of PSS/PDADMAC membranes fabricated at a stoichiometric ratio of 1.11.

FIG. 15F shows cross-sectional SEM micrographs of PSS/PDADMAC membranes fabricated at a stoichiometric ratio of 1.15.

FIG. 15G shows cross-sectional SEM micrographs of PSS/PDADMAC membranes fabricated at a stoichiometric ratio of 1.35.

FIG. 16 shows rejection of anionic methyl orange (MO) and cationic methylene blue (MB) by PSS/PDADMAC membranes prepared at stoichiometric ratios of 1.00, 1.05, and 1.11.

FIG. 17A shows turbidity of CMC/PDADMAC as a function of NaCl and KBr concentration.

FIG. 17B shows turbidity of CMC/PDADMAC as a function of cation/anion molar charge ratio.

FIG. 18A shows top down and cross-sectional micrographs of CMC/PDADMAC films at various concentrations of KBr.

FIG. 18B FIG. 18A shows top down and cross-sectional micrographs of CMC/PDADMAC membranes at various concentrations of NaCl.

FIG. 19A shows tensile test plots for CMC/PDADMAC membranes prepared across salt concentration ranges of KBr.

FIG. 19B shows tensile test plots for CMC/PDADMAC membranes prepared across salt concentration ranges of NaCl.

FIG. 19C shows Young's Modulus of CMC/PDADMAC membranes as a function of salt type and salt concentration.

### DETAILED DESCRIPTION

In non-solvent induced phase separation (NIPS), the membrane-forming polymer is dissolved in an organic solvent that is miscible with water, which is used as the non-solvent. The polymer solution is then cast, immersed, and precipitated in the non-solvent water bath, where the solvent and non-solvent exchange are initiated. Based on the tunable interaction between the three-phase system (i.e., polymer, solvent, and non-solvent) past research has manipulated the membrane structure and its corresponding separation performance. A significant drawback of the NIPS process is that the commonly used solvents, such as N-methyl-2-pyrrolidone (NMP), are repro-toxic and require an expensive recycling process. The membrane industry produces ˜50 billion liters of NMP and N,N-dimethylformamide (DMF) contaminated wastewater per year, and thus, are under increasing scrutiny by the European Chemical Agency and the United States Environmental Protection Agency. Therefore, alternative membrane chemistries that do not rely on toxic solvents are needed.

Polyelectrolyte-rich liquids, which form due to the electrostatic complexation of oppositely charged polymers in water are called complex coacervates. The self-assembly of these dense liquids is due to electrostatics, entropy and parameters, i.e., ionic strength, pH value, polymer chemistry, polymer chain length, and relative concentration of the charged polymers, can be used to control their interactions. While liquid coacervates have seen many applications including personal care and food products, more recently, research into the processing of solid polyelectrolyte complex (PEC) materials has been growing in popularity. Because of their “saloplasticity”, meaning that they can be plasticized and processed using salt and water, several manufacturing techniques, such as hot-pressing, bar coating, layer-by-layer deposition, spin coating, electrospinning, and 3D printing, have been used to process PECs into multilayer films, cargo-containing nanofibers, anion-exchange membranes, zinc-air batteries, cell scaffolds, and food packaging. Additionally, asymmetric water filtration membranes made from PECs have been realized and offer a more sustainable approach to manufacturing.

The process, termed aqueous phase separation (APS), indicates that water can serve as both the solvent and non-solvent when using PECs to prepare asymmetric porous membranes. In one example, phase transition was triggered from the liquid state to the solid membrane by changing the pH value or the salt concentration in the coagulation bath. See, e.g., Van Lente, J. J.; Baig, M. I.; De Vos, W. M.; Lindhoud, S. Biocatalytic Membranes through Aqueous Phase Separation. J. Colloid Interface Sci. 2022, 616, 903-910; and Baig, M. I.; Sari, P. P. I.; Li, J.; Willott, J. D.; De Vos, W. M. Sustainable Aqueous Phase Separation Membranes Prepared through Mild pH Shift Induced Polyelectrolyte Complexation of PSS and PEI. J. Membr. Sci. 2021, 625, 119114. Shifting the pH value in the presence of at least one weak polyelectrolyte has been demonstrated to initiate the complexation utilized to fabricate flat sheet membranes, hollow fiber membranes, natural polyelectrolyte membranes, and responsive copolymer membranes. However, the huge pH shift (i.e., from pH 12 to pH 4) requires special equipment and thus, is less amenable to scale-up.

On the other hand, by capitalizing on their saloplasticity, the salinity-induced method showed great similarity with the traditional NIPS process, where the aprotic organic solvent is replaced by an aqueous salt solution in the salinity-induced APS process. Dope solution that contains strong polycations, strong polyanions, and high salt concentration, can be precipitated in a lower salinity coagulation bath where the polyelectrolyte complexation is triggered by salt ion removal. Recent work utilizing this method has demonstrated how key parameters, such as polyanion/polycation monomer ratio, coagulation bath composition, polymer concentration and molecular weight influence the membrane structures and their separation performance. Microfiltration to nanofiltration membranes have successfully been fabricated and their corresponding separation using humic acid and salt retention have been demonstrated. However, there was limited control over the membranes' morphology and they demonstrated a low pure water permeance (<2 L m⁻²h⁻¹ bar⁻¹), as well as defects. Several methods to improve membrane performance, for example incorporating pore formers, tuning hydrophobicity, and crosslinking the formed membranes have been reported but surface defects remained. Notably, to date, only one study has utilized the polymer-rich coacervate phase as the dope solution. However, the unique ability to adjust the water content and the viscosity of the coacervate phase allows us to better manipulate and understand the pore forming mechanisms.

The present inventors have discovered that polyelectrolyte complex membranes can be fabricated from salinity-induced phase separation using a single-phase polymer-rich coacervate as the casting dope solution. In an exemplary system, the canonical, strong polyelectrolyte system of poly(sodium 4-styrene sulfonate) (PSS) and poly(diallyl dimethylammonium chloride) (PDADMAC), with the presence of potassium bromide (KBr), was shown to form the homogeneous coacervate solution that was cast into a flat sheet membrane. Coacervate composition and coagulation bath salinity were explored for effects on the final membrane structure. While salt annealing has previously been demonstrated to reduce the surface roughness and enhance the stability and salt rejection of polyelectrolyte multilayers (PEMs), it has not yet been explored for improving the performance of membranes cast using APS. Here, the PEC membranes were post-processed using salt annealing. Both the pure water permeance and dye removal by the as-prepared and the salt-annealed PEC membranes were evaluated. Additionally, anti-biofouling properties of the PEC membranes were evaluated using E. coli K12. A significant improvement is therefore provided by the present disclosure.

Accordingly, an aspect of the present disclosure is a method for the manufacture of a polyelectrolyte coacervate membrane. The terms “film”, “sheet”, or “porous membrane” may be used interchangeably with the term “membrane” herein. Advantageously, the method of the present disclosure can minimize or exclude the use of organic solvents or heat to form the polyelectrolyte coacervate membrane. Rather, the present methods alter the phase behavior of the polyelectrolyte coacervates using salt concentration, as will be further described in detail herein.

The method according to an aspect of the present disclosure comprises providing a polyelectrolyte coacervate phase comprising a polyanion, a polycation, water, and a salt. In an aspect, the polyelectrolyte coacervate phase is made by a method comprising: providing an aqueous salt solution; sequentially adding the polyanion and the polycation to the aqueous salt solution; forming a homogenous solution; phase-separating the polyelectrolyte coacervate phase from an aqueous phase to provide the polyelectrolyte coacervate phase. The term “polyelectrolyte coacervate phase” refers to a distinct phase that is rich in the polycation and the polyanion. An exemplary method for the manufacture of a polyelectrolyte coacervate phase is further described in the working examples below.

The relative amounts of the polyanion, the polycation, water, and salt are selected to facilitate formation of the polyelectrolyte coacervate. The initial salt concentration can depend, at least in part, on the identity of the polycation, the polyanion, and the salt, as will be understood by the person having skill in the art and guided by the present disclosure. In an aspect, the polycation and the polyanion can be added to the aqueous salt solution in an amount effective to provide a molar ratio of the anion monomer to cation monomer of 1.0:3.0 to 3.0:1.0, or 1.0:2.0 to 2.0:1.0, or 1.0:1.5 to 1.5:1.0 or 0.95:1.05 to 1.05:0.95. In a specific aspect, the molar ratio of the anion monomer to cation monomer can be 1:1. In another specific aspect, the molar ratio of the anion monomer to cation monomer can be 1:1 to 1:3. In an aspect, the aqueous salt solution used to prepare the polyelectrolyte coacervation can comprise salt in a concentration of 0.1 to 2 molar (M), for example 1.2 to 1.8 M, or 1.35 to 1.65 M, or 0.1 to 0.5 M, 0.2 to 0.5 M, 0.25 to 0.4 M, or 0.3 to 0.4 M. In some aspects, the polyelectrolyte coacervate can include a synthetic polycation and a synthetic polyanion, and the salt solution can have a salt concentration of 1 to 2 M, for example an 1.2 to 1.8 M, or 1.35 to 1.65 M. In some aspects, at least one of the polycation or the polyanion can comprise a natural polymer and the salt solution can have a salt concentration of 0.1 to 0.5 M, for example 0.2 to 0.5 M, 0.25 to 0.4 M, or 0.3 to 0.4 M.

Various polycations and polyanions can be used to provide the polyelectrolyte coacervate of the present disclosure and can be suitably selected by the skilled person guided by the present disclosure and depending on the desired application of the final membrane. The polycation and the polyanion can each independently be natural or synthetic polymers.

The polycation may be any suitable cationic polymers or macroions, for example, peptides or proteins, polysaccharides, polymers, nanoparticles, or surfactants. Exemplary synthetic polycations can include, but are not limited to, poly(diallyldimethylammonium chloride), poly(allylamine), poly(ethylene imine), poly(N-alkyl 4-vinyl pyridinium), poly(N-alkyl 2-vinyl pyridinium), poly([2-(acryloxy)ethyl]trimethylammonium chloride), poly(N,N-dimethyl-3,5-dimethylene piperidinium chloride), poly(vinylbenzyltrimethylammonium chloride), polyvinylamine, or a combination thereof. In an aspect, the polycation can comprise poly(diallyldimethylammonium chloride).

Exemplary natural polycations can include, but are not limited to, chitosan, poly-L-lysine, epsilon-poly-L-lysine, gelatin, histones, protamine, polymyxins, defensins, lysozyme, spermidine, and spermine.

The polyanion may be any suitable anionic polymers or macroions, for example, peptides or proteins, polysaccharides, polymers, nucleic acids, nanoparticles, or surfactants. Exemplary synthetic polyanions can include, but are not limited to, poly(styrene sulfonate), poly(acrylic acid), poly(methacrylic acid), poly(phosphate), poly(vinyl sulfonic acid), poly(2-acrylamido-2-methylpropanesulfonate), or a combination thereof. In an aspect, the polyanion can comprise poly(styrene sulfonate).

Exemplary natural polyanions can include, but are not limited to, alginate, hyaluronic acid, carrageenan, pectin, heparin, chondroitin sulfate, xanthan gum, polyglutamic acid, agar, carboxymethyl chitosan, carboxymethyl cellulose, and sulfonated cellulose.

In an aspect, a synthetic polycation and a synthetic polyanion can be used. For example, the synthetic polycation can comprise poly(diallyldimethylammonium chloride) and the synthetic polyanion can comprise poly(styrene sulfonate). In an aspect, at least one of the polycation or the polyanion can be a natural polymer. For example, in an aspect, the polycation can be synthetic and can comprise, for example, poly(diallyldimethylammonium chloride), and the polyanion can be natural and can comprise, for example, an anionic cellulose derivative such as carboxymethyl cellulose. In an aspect, both the polycation and the polyanion can be naturally occurring polymers.

Various salts are also contemplated for use in the present disclosure. The particular salt can be selected based on the polycation and the polyanion selected. Exemplary salts can include, but are not limited to, potassium bromide, sodium chloride, potassium chloride, sodium bromide, sodium thiocyanate, guanidinium bromide, guanidinium thiocyanate, or a combination thereof. In a specific aspect, the salt comprises potassium bromide.

The polyelectrolyte coacervate phase can optionally comprise one or more additional additives, for example depending on the desired final application for the membrane. The additives can be selected to tune the chemical or mechanical properties or the selectivity of the membrane structure and are further selected to as to not adversely affect one or more desired properties of the membrane. Exemplary additives can include fillers, such as inorganic particulate materials. In an aspect, no additives or fillers are present.

The method further comprises coating the polyelectrolyte coacervate phase onto a substrate to provide a coated substrate (i.e., a substrate having a coating comprising the polyelectrolyte coacervate phase disposed on at least a portion of a surface of the substrate). Any suitable deposition method can be used to coat the polyelectrolyte coacervate phase onto the substrate. For example, the polyelectrolyte coacervate phase can be coated by spin coating, spray coating, blade coating, roll casting, dip coating, and the like, or a combination thereof. In an aspect, the polyelectrolyte coacervate phase can be deposited by additive manufacturing processes (i.e., three-dimensional printing). Preferably, the deposition technique can be selected so as to provide a substantially uniform film of the polyelectrolyte coacervate phase on the surface of the substrate. In some aspects, evaporation of solvent (e.g., water) can be avoided during the coating process so as to preserves the polyelectrolyte coacervate structure, which can be influenced by concentration. In some aspects, for example when a denser coating may be preferred, at least a portion of the solvent may be evaporated during the coating process.

A variety of substrates can be used for the present disclosure. In an aspect, the substrate can be a porous material. In an aspect the substrate is selected so as to not hinder the passage of a permeate through the membrane (i.e., the substrate can be porous). The substrate can preferably be an inert material which does not react with the polyelectrolyte coacervate phase, the coagulation bath, water, or the salt. In some aspects, the substrate may not be required to be inert. In an aspect, the substrate can comprise a woven, a nonwoven, or a porous material. Exemplary substrates can include, but are not limited to, a non-woven polymeric material, such as a polyester, polyethylene, polypropylene, polyetherether ketone (PEEK), polyphenylene sulfide (PPS), ethylene-chlorotrifluoroethylene, cellulose, cellulose acetate, or a carbon fiber material. In some aspects, a solid (e.g., nonporous) substrate may be used, for example glass, ceramic, or metal plates. Preferably, when a solid substrate is used, the membrane can be subsequently removed from the substrate to provide a free-standing polyelectrolyte coacervate membrane.

The method further comprises immersing the coated substrate comprising the film of polyelectrolyte coacervate phase in a coagulation bath to provide a polyelectrolyte coacervate membrane. In some aspects, the coagulation bath can be an aqueous coagulation bath. The term “aqueous coagulation bath” includes the use of both pure water and aqueous salt solutions. When an aqueous salt solution is used, the concentration of the salt is less than the concentration of salt in the polyelectrolyte coacervate phase. Exemplary salt concentrations for the aqueous coagulation bath can include zero (i.e., pure water), up to a concentration of 1 M. Within this range, the salt concentration for the aqueous coagulation bath can be 0 to 0.5 M, or 0.1 to 0.5 M, or 0.2 to 0.4 M. Salt concentrations of greater than 1 M are also contemplated by the present disclosure, for example 1 to 5 M, or 1 to 4 M, or 1 to 3 M, or 1 to 2 M.

In some aspects, the coagulation bath can comprise an organic solvent. For example, the coagulation bath can comprise a C₁₋₆ alcohol, for example methanol, ethanol, isopropanol or the like. Combinations of any the foregoing solvents may be used (e.g., combinations of two or more organic solvents or combination of water (or aqueous solution) and an organic solvent, preferably wherein the organic solvent is miscible with water).

The ionic species present in the aqueous coagulation bath can be the same or different as the salt in the polyelectrolyte coacervate phase. In an aspect, the ionic species comprises salt, and the salt present in the aqueous coagulation bath is the same as the salt in the polyelectrolyte coacervate phase. Exemplary salts can include, but are not limited to, potassium bromide, sodium chloride, potassium chloride, sodium bromide, sodium thiocyanate, guanidinium bromide, guanidinium thiocyanate, or a combination thereof. In an aspect, the salt comprises potassium bromide. Other suitable ionic species can include, but are not limited to, peptides, nanoparticles, metal ions, or combinations of any of the foregoing.

In some aspects, crosslinking agents or pore formers can be present in the coagulation bath. For example, in an aspect, glutaraldehyde, glycerol, a water soluble polymer (e.g., polyethylene glycol), or a combination thereof can be present. Other crosslinking agents or pore formers are contemplated by the present disclosure and can be suitably selected by the skilled person based on the other components of the system and guided by the present disclosure.

Exposure to the coagulation bath can be for a time effective to reduce the salt concentration of the polyelectrolyte coacervate phase coating, thereby inducing complexation of the polycation and the polyanion to form strongly bound polyelectrolyte coacervates, and precipitation (e.g., solidification) of the polyelectrolyte coacervates to provide the polyelectrolyte coacervate membrane. The polyelectrolyte coacervate membrane is therefore solid but retains porosity. In an aspect, the time effective in the coagulation bath can be at least 1 minute, or at least 5 minutes, or at least 10 minutes, or at least 15 minutes, or at least 20 minutes, or at least, 30 minutes, or at least 60 minutes, or at least 120 minutes, or at least 3 hours, or at least 5 hours, for example 1 minute to 10 hours, or 5 minutes to 3 hours, or 5 minutes to 1 hour, or 30 minutes to 10 hours, or 30 minutes to 3 hours, or 30 minutes to 2 hours. In an aspect, immersion in the coagulation bath can occur prior to any drying of the membrane. In an aspect, immersion in the coagulation bath can be at a temperature of less than 50° C., for example less than 40° C., or less than 30° C., or 15 to 30° C., or 15 to 25° C. Preferably, immersion in the coagulation bath can be at room temperature.

Optionally, the method can further comprise removing salt from the polyelectrolyte coacervate membrane after immersing in the coagulation bath. For example, the polyelectrolyte coacervate membrane can be subjected to water washing or soaking in pure water to remove salts.

The method further comprises annealing the polyelectrolyte coacervate membrane to provide an annealed polyelectrolyte coacervate membrane. In an aspect, the annealing can be a thermal annealing process, which comprises heating the polyelectrolyte coacervate membrane to a temperature effective to anneal the membrane (e.g., based on the glass transition temperature of the membrane).

In an aspect, the annealing can be a salt annealing process, for example comprising immersing the polyelectrolyte coacervate membrane in an aqueous medium to provide the annealed polyelectrolyte coacervate membrane. The present inventors have unexpectedly found that a post-processing salt annealing step can improve the pure water permeance of the membranes, improve selective rejection of a compound, and provide improved anti-fouling properties. Thus, the salt annealing can provide certain advantages which make the membranes of the present disclosure particularly well suited for nanofiltration applications.

The aqueous medium to anneal the polyelectrolyte coacervate membrane comprises a salt. The salt can be selected based on the identity of the polyanion and the polycation. Preferably the salt is capable of effecting a glass transition of the polyelectrolyte coacervate. The concentration of the salt in the aqueous medium for annealing can therefore be selected based on the particular salt and the polyanion and the polycation, as the concentration must be sufficient to effect the glass transition. In an aspect, the salt can comprise NaCl, KCl, LiCl, NaBr, KBr, LiBr, NaI, KI, LiI, Na₂SO₄, NaNO₃, CaCl₂, MgCl₂, MgSO₄, ammonium formate, as well as transition metal salts, lanthanides, or actinides. In a specific aspect, the salt can comprise NaCl (sodium chloride). In an aspect, the aqueous medium to anneal the polyelectrolyte coacervate membrane comprises a salt in a concentration of 1 to 2 M, preferably 1.2 to 2 M, or 1.3 to 2 M, or 1.4 to 2 M, or 1.5 to 2M. It is noted that in place of salt, an ionic species could be used for the annealing, for example peptides, nanoparticles, metal ions, or combinations of any of the foregoing.

In some aspects, no annealing step is required. For example, when the polyelectrolyte coacervate membrane comprises at least one natural polymer, the annealing step may be omitted. In a specific aspect, when the polyelectrolyte coacervate membrane comprises carboxymethyl cellulose, the annealing step may be omitted.

Optionally, the method can comprise an ion exchange step. For example, the aqueous medium to anneal the polyelectrolyte coacervate membrane can comprise a charged species other than a salt (e.g., peptides, nanoparticles, metal ions, or combinations of any of the foregoing). The method can therefore provide an annealed polyelectrolyte coacervate membrane that has been post-functionalized with a different charged species.

Optionally, the method can further comprise removing salt from the annealed polyelectrolyte coacervate membrane. For example, the annealed polyelectrolyte coacervate membrane can be subjected to water washing or soaking in pure water to remove salts.

In an aspect, the annealing step can comprise a combination of salt annealing and thermal annealing.

The method can optionally further comprise drying the polyelectrolyte coacervate membrane (i.e., removing water from the polyelectrolyte coacervate membrane). Any suitable water removal technique can be used, for example drying using a nitrogen air gun, heating, lyophilization, and the like. Preferably, drying does not affect the porosity of the membrane. In an aspect, the membranes can be stored and used in their hydrated form.

The method can optionally further comprise removing the substrate from the polyelectrolyte coacervate membrane.

A polyelectrolyte coacervate membrane represents another aspect of the present disclosure. The polyelectrolyte coacervate membrane can be made by the method described herein. Accordingly, a polyelectrolyte coacervate membrane comprises a complexed polyanion and a polycation.

The polyelectrolyte coacervate membrane is porous. The pores of the polyelectrolyte coacervate membrane can be open (i.e., interconnected), closed, or a combination thereof. In an aspect, the pores can preferably be spherical in shapes, but other shapes are also possible, including for example elongated pores in the form of channels. The pores can be distributed throughout the polyelectrolyte coacervate membrane. The pores can have an average diameter of, for example, 1 nanometer (nm) to 1 micrometer (μm). Within this range, the average pore diameter can be 10 to 750 nm, or 100 to 500 nm, or 100 nm to 1 μm, or 500 nm to 5 μm. In an aspect, the polyelectrolyte coacervate membrane can have a porosity of, for example, 10 to 90 volume percent, or 10 to 80 volume percent, or 10 to 70 volume percent, or 10 to 60 volume percent, or 20 to 60 volume percent, or 50 to 90 volume percent.

In an aspect, the polyelectrolyte coacervate membrane can comprise distinct sublayers of the membrane. In an aspect, the polyelectrolyte coacervate membrane comprises two sublayers. A first sublayer can be a dense skin layer can be nonporous or may include pores which are smaller than the pores of the porous layer (e.g., in the range of 1 to 50 nm, or 1 to 25 nm, or 1 to 10 nm). The porous layer, which underlies the dense skin layer can comprise pores having the average pore diameter discussed above.

The polyelectrolyte coacervate membrane can have an average thickness of, for example, 50 to 300 μm, or 50 to 150 μm. Thickness of the polyelectrolyte coacervate membrane as used herein refers to the total thickness of the membrane, including both the dense skin layer, when present, and the porous layer. In an aspect, the dense skin layer can have a thickness of 1 to 10 micrometers.

The polyelectrolyte coacervate membrane described herein can exhibit one or more desirable properties. For example, the polyelectrolyte coacervate membrane can exhibit a pure water permeance of 1 to 10 L m⁻² h⁻¹ bar⁻¹. In an aspect, the polyelectrolyte coacervate membrane can have a surface zeta potential of greater than −60 to +60 mV, or 0 to +60 mV, or 0 to +50 mV. In an aspect, the polyelectrolyte coacervate membrane can exhibit reduced biofouling compared to glass. In an aspect, the polyelectrolyte coacervate membrane can be capable of rejecting at least 90% of an anionic molecule having a molecular weight of less than 500 grams per mole. In an aspect, the polyelectrolyte coacervate membrane can be capable of rejecting at least 90% of a cationic molecule having a molecular weight of less than 500 grams per mole. In an aspect, the polyelectrolyte coacervate membrane can be capable of rejecting at least 90% of a net neutral molecule having a molecular weight of less than 500 grams per mole. It will be understood that rejection of the anionic, cationic, or net neutral species can depend on the surface zeta potential of a membrane.

The polyelectrolyte coacervate membrane can be useful in a variety of applications. An exemplary application is filtration, for example including both liquid filtration (e.g., water filtration, organic solvent filtration, dye separation, pharmaceuticals separation, nanoparticle/particle suspensions, or oil filtration). A filtration method can comprise passing a liquid feed stream (e.g., comprising water, organic solvent, aqueous solution, organic solution, and the like) through the polyelectrolyte coacervate membrane. In an aspect, the polyelectrolyte coacervate membrane can be incorporated into any number of conventional systems for water or organic solvent or solution purification.

This disclosure is further illustrated by the following examples, which are non-limiting.

### EXAMPLES

Materials and Chemicals. All chemicals were used as received. Poly(sodium 4-styrene sulfonate) (PSS, 30 wt. %, average Mw ˜200,000 Da), and poly(diallyl dimethylammonium chloride) (PDADMAC, 20 wt. %, Mw 200,000˜350,000 Da) were purchased from Sigma-Aldrich and used as the polyanion and polycation, respectively. Methylene blue (MB, Biological Stain Commission), glycerol (>99.5%), M9 minimal salts (M9 media), tryptone, and yeast extract, were also purchased from Sigma-Aldrich. Potassium bromide (KBr, ACS grade) and methyl orange (MO, ACS grade) were purchased from Thermo Scientific. Sodium chloride (NaCl, Granular/USP/FCC), poly(ether sulfone) (PES) 1000 molecular weight cut-off (MWCO) membranes (Sartorius) were purchased from Fisher Scientific and used as controls. Spectinomycin dihydrochloride pentahydrate (USP grade) was purchased from Gold Biotechnology™ (Olivette, MO). Deionized (DI) water was obtained from a Barnstead Nanopure Infinity water purification system (Thermo Fisher Scientific, Waltham, MA). Membranes were hand-cast onto Hollytex™ Grade 3324 Nonwoven filter paper that was purchased from Kavon Filter Products Co (Wall Township, NJ). Escherichia coli K12 MG1655 (E. coli) was purchased from DSMZ (Leibniz-Institut, Germany).

Coacervate Preparation. Individual PSS and PDADMAC stock solutions were prepared gravimetrically at a concentration of 1 molar (M) with respect to their monomer units. KBr concentration was prepared at a concentration of 4 M. A complex coacervate was prepared by mixing KBr stock solution with water in a beaker, followed by sequential addition of PSS and PDADMAC stock solutions. The PSS and PDADMAC monomer ratio was 1:1 at a total PEC concentration of 0.4 M for all samples. The KBr concentrations in the mixture were tested at three different concentrations: 1.4, 1.5, and 1.6 M. The mixture was stirred for 1 hour to form a homogeneous solution before being poured into a 500 mL separatory funnel. After 14 days, the coacervate phase was completely phase separated from the supernatant phase and stored in 50 mL centrifugal tubes at room temperature until use.

Membrane Fabrication. The viscous coacervate phase, prepared at different KBr concentrations, was hand-cast onto a 10.2×15.3 cm Hollytex™ nonwoven filter paper which was secured using lab tape (Scotch™ Magic™ tape, 3M) to a glass plate (17.8×25.4 cm). A casting knife (5.08×5.08 cm, Gardco Inc., Pompano Beach, FL) with a gate height of 10 mil (0.254 mm) was used to spread the coacervate into a thin layer on the glass plate. After casting, the whole assembly was immediately immersed in a deionized (DI) water coagulation bath that contained either 0 M, 0.2, or 0.4 M KBr(aq) for 1 hour at room temperature. The as-prepared membranes were rinsed 3 times with DI water before being stored in a DI water bath overnight at room temperature to ensure that all residual salt was removed before membrane use. Table 1 shows precursor compositions for membranes prepared for the present examples by APS, including the KBr concentration (C_{KBr}) in the coacervate dope solution (first column) and coagulation bath (top row). The nomenclature of the membranes presented in the following examples is also shown in Table 1.

TABLE 1

| | 0M_{(aq)} | 0.2M_{(aq)} | 0.4M_{(aq)} |
|---|---|---|---|
| 1.4M | * | * | 1.4/0.4 |
| 1.5M | 1.5/0 | 1.5/0.2 | 1.5/0.4 |
| 1.6M | * | * | 1.6/0.4 |

* Membranes fabricated from these conditions had minimal permeance or were not evaluated

Salt annealing of the as-prepared membranes was also explored. Here, the as-prepared membranes were immersed in a 1.6 M NaCl solution for 16 hours, followed by DI water rinsing 3 times before storing the membranes in a DI water bath at room temperature. From each hand-cast membrane sheet, three coupons (1-inch diameter circle) were punched out using a Spearhead 130 Power Punch MAXiset (Fluid Sealing Services, Wausau, WI). All membranes were used within 14 days of fabrication.

Membrane Performance Tests. Membrane filtration was conducted using a 10 mL dead-end stirred cell (Sterlitech, Auburn, WA). The effective membrane area reported by the manufacturer was 3.5 cm². The stirred cell was pressurized using a nitrogen tank, where the transmembrane pressure was measured using a digital pressure gauge purchased from Cole-Palmer. All membranes were compacted for 1 hour at 3 bar transmembrane pressure (TMP) to achieve steady water flux before further testing. For pure water permeance measurements, the permeate weight (M) was recorded at 15-min intervals for 2 hours using a digital weighing scale (U.S. Solid, Cleveland, OH). The pure water permeance (PWP) reported was an average over the 2 hour test and determined using Equation 1

$$PWP ( L {m}^{- 2} {h}^{- 1} {bar}^{- 1} ) = \frac{J ( L {m}^{- 2} {h}^{- 1} )}{TMP ( bar )} = \frac{\frac{M ( kg )}{ρ ( kg {L}^{- 1} ) A ( {m}^{2} ) Δ t ( h )}}{TMP ( bar )} \qquad ( 1 )$$

where J is the pure water flux, ρ is the density of water, A is the effective membrane area, and Δt is the measurement time. For each casting condition, at least three membrane samples were tested.

Poly(ethylene glycol) (PEG) rejection measurements were performed separately with three molecular weights (600, 1000, and 2000 Da) using a PEG feed concentration of 1 g/L for each molecular weight. Membranes were first compacted before being tested at 3 bar TMP until 4 mL of permeate was collected. Feed and permeate solutions were dried and redissolved in an eluent consisting of 80/20 0.1 M sodium nitrate/acetonitrile solution for analysis using gel permeation chromatography with a size exclusion column (Agilent 1200/1260 Infinity GPC/SEC series). The solution flow rate was 1 mL/min and went through three Waters™ Ultrahydrogel Linear Columns (WAT011545, 10 μm, 7.8×300 mm²) in series. In order to calculate PEG concentration, calibration curves for each molecular weight of PEG were prepared. PEG rejection was calculated using Equation 2:

$$PEG Rejection ( \% ) = ( 1 - \frac{{C}_{p}}{{C}_{f}} ) \times 100 \qquad ( 2 )$$

where Cₚ and C_{f} are the permeate and feed PEG concentrations, respectively. For each casting condition, at least three membrane coupons were tested.

Dye Adsorption Test. Single-component adsorption tests were performed by immersing 5 mL of 12.5 ppm MO or MB solution with a membrane coupon (1.57 cm diameter circle). The membrane mass was recorded before it was secured using tape to the base of a well within a 12-well plate, where the absorbance of the dye solution in each well was measured using a BioTek Synergy HTX Multi-mode Reader. The adsorption was studied for 24 h; the first hour was measured in 15 min intervals followed by 60 min intervals. The dye adsorption percent was calculated using Equation 3,

$$Adsorption ( \% ) = ( 1 - \frac{{A}_{a}}{{A}_{b}} ) \times 100 \qquad ( 3 )$$

where A_{b} and Aₐ are the dye solution absorbance before and after adsorption, respectively.

Steady-State Dye Rejection Performance. To characterize the selectivity of our membranes, we filtered a 100 mg/L aqueous solution containing equal concentrations of MO and MB dyes through our membranes using the dead-end stirred cell at 3 bar for 2 h. The feed solution was stirred at 600 ppm to minimize concentration polarization. To obtain steady-state separation performance, all membranes were saturated in the feed solution for 24 h before testing to eliminate the contribution of adsorption from dye removal. The first hour of the filtrate was discarded because it might include adsorption from the dead-end cell, the second hour of the filtrate was collected and analyzed by a UV-vis spectrophotometer (Thermo Scientific Genesys 10S). Dye rejection is defined by Equation 4,

$$Rejection ( \% ) = ( 1 - \frac{{A}_{p}}{{A}_{f}} ) \times 100 \qquad ( 4 )$$

where A_{f} is the feed absorbance, and Aₚ is the permeate absorbance. The absorbance of MO and MB were measured at their peak wavelength (λₘₐₓ), which are 465 and 665 nm, respectively. Calibration curves for both dyes were also prepared, and linear regression between absorbance and dye concentration was confirmed. Three samples from the as-prepared, salt-annealed membranes and control were tested.

Membrane Characterization. The membrane's thickness (Z) when wet was measured at five different locations on every membrane coupon before and after filtration using a Mitutoyo 293-330 digital micrometer (Toronto, Ontario, Canada). The surface morphology and cross-sectional structure of the fabricated membranes were examined by a scanning electron microscope (FEI Magellan 400 XHR-SEM, ThermoFisher Scientific, Hillsboro, OR). Membranes for SEM analysis were cast directly onto plastic sheets. Free-standing membranes were peeled off from the plastic sheet before immersing them in 20% w/v glycerol solution overnight to prevent their pores from collapsing. Next, the membranes were immersed in liquid nitrogen, fractured, and placed on flat and 90° stubs to obtain both top-down and cross-sectional SEM images. Samples were sputtercoated (Cressington 108 Sputter Coater, Watford, UK) with 6 nm of gold before imaging. The membrane and skin layer thickness of the dry as-prepared membranes were analyzed using ImageJ software for at least 10 different locations from three separate cross-sectional SEM images.

The surface zeta potential of the membrane was measured using the Zetasizer Nano ZSP with a surface zeta potential cell (Malvern Panalytical, MA). Membrane samples were glued onto the surface zeta potential cell with epoxy (Loctite™ Epoxy Instant Mix™) and immersed in tracer particles containing solution. Tracer solution used for anionic samples was purchased from Malvern Panalytical (ZTS1240); whereas diluted fabric softener solution (0.8 μL/mL H₂O) was used for the cationic sample.

Membrane surface topography images were acquired using a Cypher ES atomic force microscope (AFM, Asylum Research/Oxford Instruments, Santa Barbara, CA). Samples were scanned in water using alternating current (AC) mode and the OPUS AC-240 (k=2 N/m) probe (NanoAndMore, Watsonville, CA). Before scanning, the probe was thermally calibrated in the air to determine its spring constant (k=2 N/m) and its resonance frequency (˜65 kHz) using the blue drive. Subsequently, the probe was moved to the hydrated surface and confirmed to be fully submerged in water. Then, thermal calibration was applied again to obtain the lever sensitivity underwater with the constant spring constant (k=2 N/m). After acquiring lever sensitivity, the probe was tuned with drive amplitude (9 mW) to receive frequency underwater (˜25 kHz). When the scans were completed, the topographical images of hydrated membranes were analyzed with IgorPro (Wave-Metrics, Inc., Lake Oswego, OR) to quantify the surface roughness including root mean square roughness (R_{q}), average roughness (R_{avg}), skewness (R_{skw}), kurtosis (Rₖᵤᵣₜ), minimum roughness (Rₘᵢₙ), and maximum roughness (Rₘₐₓ). Measurements were collected on 3 samples each for the as-prepared, salt-annealed, and Sartorius control membranes.

Antifouling Characterization. The Gram-negative microorganism E. coli containing a green fluorescent protein (GFP) plasmid was used in antibiofouling studies. Overnight cultures of E. coli were inoculated in Luria Bertani (LB) broth with spectinomycin (1 μL mL⁻¹) for 16 hours at 37° C., resuspended in M9 media to a concentration of 107 CFU/mL before antibiofouling tests. Static fouling resistance tests were conducted on as-prepared, salt-annealed, Sartorius control membranes and internal glass controls by placing them in separate wells of six-well polystyrene plates and exposing them to 5 mL of E. coli suspension without shaking for 24 h at 37° C. Samples were then rinsed with M9 media three times to remove loosely attached cells. Visualization of the GFP plasmid containing E. coli was captured using a Zeiss Axio Imager A2 M Microscope (Carl Zeiss Microscopy, White Plains, NY). Random images (n=15) were acquired over three parallel replicates and analyzed using ImageJ software to calculate the bacteria area coverage.

Statistics. All statistical significance was determined using a two-tailed, unpaired student t-test. Error bars shown throughout the results are standard deviations unless specified.

### Results

The non-solvent induced phase separation (NIPS) process is used to manufacture robust membranes using neutral polymers and aprotic solvents. Here the same processing steps, i.e., immersing a polymer solution film in a nonsolvent bath, were explored, but using a single phase coacervate dope solution, so that robust and high-performance aqueous phase separation (APS) membranes can be developed. First selection of the concentration of salt (KBr) in the membrane-casting dope solution (i.e., coacervate) and the coagulation bath was explored. The success of changing the salt concentration was assessed by analyzing the pore structure and pure water permeance of the formed membranes. Then, a salt annealing post-treatment was introduced to determine the effect on membrane filtration performance, for example, the rejection of dye molecules. Finally, the antibiofouling of the polyelectrolyte complex (PEC) membranes was investigated.

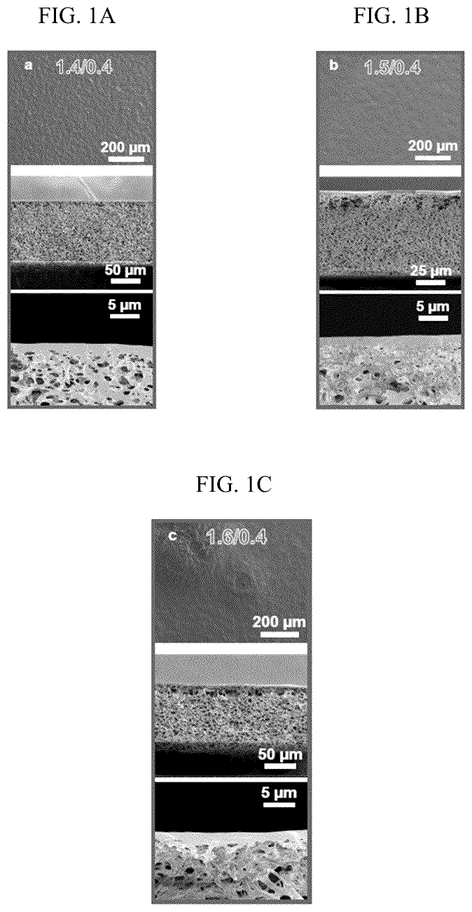

Impact of Coacervate Composition on Membrane Structure and Performance. First, the effect of coacervate KBr concentration on membrane formation was studied. A thin layer of homogeneous coacervate (PSS:PDADMAC at a monomer ratio of 1:1) containing varied KBr concentrations (1.4, 1.5 and 1.6M) was cast into a film that was immersed in a 0.4M KBr(aq) coagulation bath (Table 1). The as-prepared membranes will be referred to as 1.4/0.4, 1.5/0.4 and 1.6/0.4, respectively. The top-down, cross-sections and enlarged cross-sectional SEM micrographs of the membranes are shown in FIG. 1. No visible pores were observed on 1.4/0.4 and 1.5/0.4 surfaces, where we started to see small pinholes on the 1.6/0.4 KBr membranes. All cross-sectional micrographs revealed an asymmetric pore structure, where the sponge-like interconnected substructure and dense skin-layer morphology indicate successful membrane fabrication. Though no macrovoids were observed for these membranes, 1.5/0.4 and 1.6/0.4 show signs of inconsistent morphology and possibly delamination near the upper part of the porous substructure, which might lead to decreased mechanical stability. From the micrographs, the dry thickness of the dense skin layer, which was measured using ImageJ, varied between 1.29 and 1.58 μm. Overall, visually, the morphology of the three membranes did not substantially differ from each other.

The precipitation mechanism of APS is similar to NIPS: as the solution viscosity increases, the onset of the precipitation is delayed, resulting in smaller pore sizes and denser structures. To date, only one paper has utilized the coacervate phase to fabricate membranes via the APS process. See, e.g., Sadman, K.; Delgado, D. E.; Won, Y.; Wang, Q.; Gray, K. A.; Shull, K. R. Versatile and High-Throughput Polyelectrolyte Complex Membranes via Phase Inversion. ACS Appl. Mater. Interfaces 2019, 11 (17), 16018-16026. Sadman et al. explored a PSS/poly(N-ethyl-4-vinylpyridinium) (QVPC2)/KBr polyelectrolyte coacervate system, where the coacervate KBr concentration was varied from 15.1 to 18.3 wt %. With increasing KBr concentration, the skin layer transitioned from completely dense to having 10-100 nm pores. Moreover, the thickness of the skin layer increased significantly with decreasing KBr concentration. The morphological changes can again be explained by the kinetics of precipitation. When the coacervate salt concentration increases, the polyelectrolyte concentration decreases with increasing water content. Most importantly, coacervate viscosity increases with decreasing salt concentration. The restricted polyelectrolyte chain mobility and higher polyelectrolyte concentration eventually lead to a thicker skin layer and lower overall porosity. However, the dry thickness of the skin layer and the overall porosity of the as-prepared membranes according to the present disclosure seemed very similar; we note that these observations were made under the vacuum of the SEM, post-preparation via liquid nitrogen flash freezing and cracking.

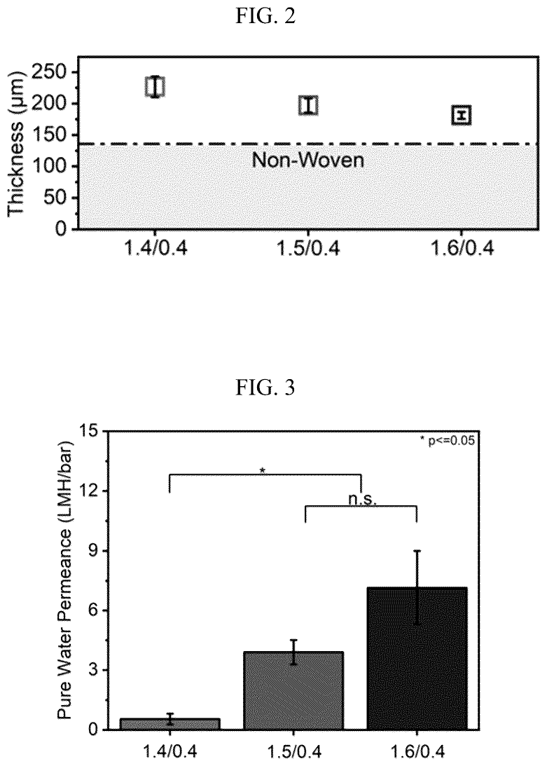

It was found that the wet thickness of the membranes, which rarely is reported, decreased with higher KBr concentration, as summarized in FIG. 2. The wet thickness of the as-prepared 1.4/0.4, 1.5/0.4 and 1.6/0.4 PEC membranes, including the nonwoven support (135 μm) were 227, 197 and 181 μm, respectively. Potentially, casting coacervates with higher KBr concentrations and lower polyelectrolyte content reduces the mechanical stability of a porous substructure. During and after precipitation, the 1.6/0.4 membrane pores could undergo more compaction when they theoretically should possess higher porosity.

To investigate the membrane performance, pure water permeance (PWP) tests were conducted at 3 bar with a dead-end filtration setup. The PWP of the 1.4/0.4, 1.5/0.4 and 1.6/0.4 membranes were determined to be 0.81, 3.9 and 7.2 L m⁻² h⁻¹ bar⁻¹, respectively, see FIG. 3. The PWP decreased with increasing membrane thickness resulting from lower water transport through the porous substructure. The larger standard deviation demonstrated by the 1.6/0.4 membranes suggests that their pore structure was less mechanically stable, whereas the 1.4/0.4 membranes showed a lower but more consistent performance benefiting from the delamination-free structure. The most consistent performance was by the 1.4/0.4 membranes, however, their PWP was quite low for nanofiltration applications, which likely resulted from the high viscosity of the 1.4M KBr coacervate dope solution. Therefore, membranes cast from the 1.5M KBr coacervate will be used throughout the rest of the examples.

Impact of Coagulation Bath Salinity on Membrane Structure and Performance. Coagulation bath salinity is another membrane fabrication parameter that was investigated. Accordingly, membranes were cast from optimized 1.5M KBr coacervates and immersed in 0 (pure water), 0.2, and 0.4M KBr(aq) coagulation baths, which will be referred to as 1.5/0, 1.5/0.2, and 1.5/0.4, respectively (Table 1).

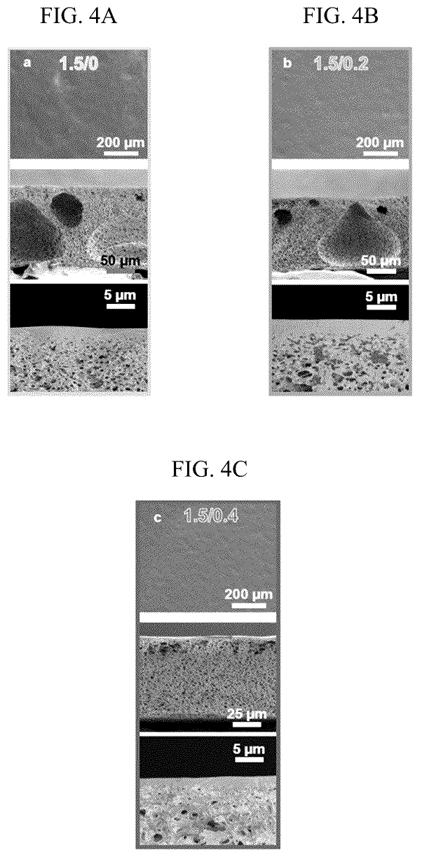

FIG. 4 shows the SEM images of cast membranes post-submersion in coagulation baths with different salinities. No visible pores were found on the surface of any of these membranes. It was also observed that all membranes had an asymmetric structure with a dense skin layer but with different substructure morphologies. The 1.5/0 and 1.5/0.2 membranes both contained “waterdrop-like” macrovoids within the substructure, indicating an instantaneous demixing mechanism with a relatively high precipitation rate. However, for the 1.5/0.4 membranes, a sponge-like morphology with open interconnected pores was observed, indicating a slower, delayed demixing mechanism. The salt ions in the coagulation bath likely limited the release of counter-ions from the polyelectrolytes, whereas a higher coagulation bath salinity would create a slower precipitation rate resulting in a less porous pore structure. Also, the presence of salt within the bath increases the chain mobility of the polyelectrolytes, especially near the membrane's surface. Thus, the polyelectrolyte chains can better associate during precipitation, which has proved to create a denser and thicker skin layer.

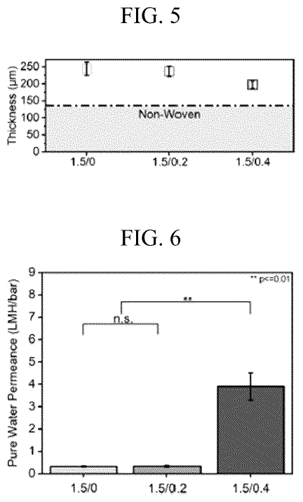

Visually, no substantial difference was observed in either the porosity or the thickness of the dense layer from changing the coagulation bath salinity. The wet membrane thickness decreased with increasing bath salinity; the wet thickness is summarized in FIG. 5. The wet thickness of the 1.5/0, 1.5/0.2 and 1.5/0.4 membranes are 243, 236, and 196 μm, respectively. The PWP of the 1.5/0, 1.5/0.2 and 1.5/0.4 membranes again increased with decreasing wet thickness, which were 0.33, 0.34, and 3.9 L m⁻² h⁻¹ bar⁻¹, respectively (FIG. 6). Even though the 1.5/0.4 membrane had a lower porosity substructure, the membrane's wet thickness still acts as the dominating factor. However, it is also possible that the macrovoids in the 1.5/0.2 and 1.5/0.4 structures would simply collapse during filtration, which would lead to a more compact structure and result in minimal PWPs. In conclusion, the 0.4M KBr(aq) coagulation bath salinity along with 1.5 M KBr coacervate salt concentration yielded the membrane that provides the steadiest, most consistent, and reasonable PWP for nanofiltrations applications, which will be used in further examples.

Impact of Salt Annealing on Membrane Structure and Performance. Coacervate materials are saloplastic and previous literature has used salt post-processing methods to decrease the roughness and enhance the performance of other polyelectrolyte-containing materials. Thus, here the 1.5/0.4 membranes were post-treated using a 1.6 M NaCl water bath. This salt was selected because PSS/PDADMAC complexes are known to undergo a glass transition for NaCl concentrations higher than 1.5M or temperatures higher than 45° C., which allows the polyelectrolyte chains to rearrange.

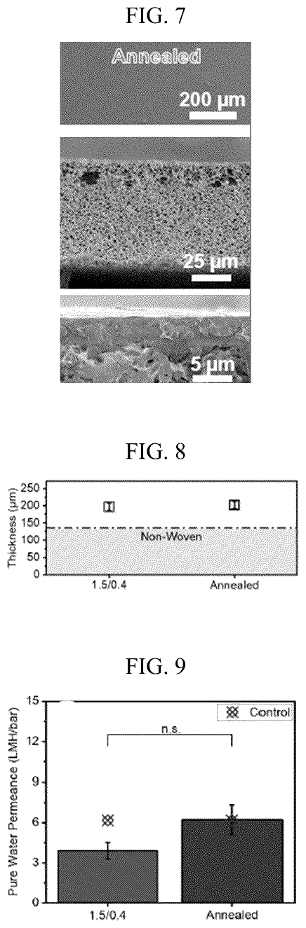

The SEM images of the salt-annealed membranes are shown in FIG. 7, where the membrane morphologies did not show a significant difference from the as-prepared 1.5/0.4 membranes, shown in FIG. 4. Cross-sectional images suggest that they have an asymmetric pore structure and notably, the skin layer thickness was observed to be increased from 1.44 to 5.15 μm after annealing, possibly resulting from polyelectrolyte chain rearrangement near the membrane surface. The dry and wet thickness, as well as PWP performance, are summarized FIGS. 8 and 9, respectively. The average wet thickness trended to increase from 197 to 203 μm after annealing, though this was not a statistically relevant change. The average PWP did increase from 3.9 to 6.2 L m⁻² h⁻¹ bar⁻¹. The increase in the degree of swelling or hydration ratio after annealing can be explained by several factors from salt-annealed polyelectrolyte multilayers (PEM) studies. First, salt annealing of PEMs at high ionic strength is shown to favor compensation by counterions, shifting intrinsic compensation (oppositely charged polyelectrolytes) towards extrinsic compensation (charged balanced by counterions). This transition will increase the charge density, as well as the degree of swelling that leads to a more hydrated PEM layer. Also, PDADMAC-terminated PSS/PDADMAC PEMs have been reported to have a higher swelling degree than PSS-terminated films, therefore making the multilayer less dense. PDADMAC overcompensation was also been found in APS membranes, even when preparing membranes from equimolar of PSS and PDADMAC, the surface zeta potential was ˜+5 mV.

The annealing of the present membranes could pull the excess PDADMAC to the surface leading to an even more net positive membrane and thus higher hydration ratio. In the present case, given the fact that the membrane morphology did not change significantly, the effect of salt annealing on PWP was expected to be minimal. A slight (but not statistically relevant) increase in the PWP suggests that a more hydrated and less dense membrane is obtained after annealing, even with a thicker skin layer. The PWP value after annealing is nearly identical to the commercial control membrane, shown in the red symbol in FIG. 9. It is worth noting that the increase in hydration ratio is not found in membranes fabricated under different conditions. For example, the average thickness of 1.5/0.2 membranes decreased by 30%, potentially because the relatively unstable macrovoids become compressed or even collapsed during chain rearrangement.

Effect of Using a Single Phase Coacervate as the Dope Solution. How utilizing the coacervate phase (polymer-rich phase) differs from using an overcritical one-phase solution as a casting solution was explored. For comparison, the present membranes were compared to ultrafiltration and NF membranes from different PSS:PDADMAC monomer ratio solutions and using a DI water coagulation bath. See, e.g., Kamp, J.; Emonds, S.; Borowec, J.; Restrepo Toro, M. A.; Wessling, M. On the Organic Solvent Free Preparation of Ultrafiltration and Nanofiltration Membranes Using Polyelectrolyte Complexation in an All Aqueous Phase Inversion Process. J. Membr. Sci. 2021, 618, 118632. First, the morphologies and PWPs of 50:50 and 55:45 membranes were similar to the present 1.5/0.4 membrane, where a dense skin layer is followed by a porous interconnected substructure showing an NF PWP range. Since the coacervate phase represents a distinct point on the binodal curve, the demixing starts immediately when the cast film enters the coagulation bath, which always leads to a rapid polymer complexation and the formation of a more porous skin layer. In the present application, to achieve a delayed demixing within the coacervate phase, there is a need to raise the coagulation bath salinity to 0.4 M, whereas only water is needed for the overcritical casting solution. Therefore, the coacervate phase has a smaller coagulation bath salinity window to work with and might be more sensitive to salinity changes in the bath.

Another prior report starting from an equal PDADMAC to PSS molar ratio found that the PDADMAC content in the polymer-lean phase was higher, possibly because KBr is a better solvent for PDADMAC than PSS. See, e.g., Wang, Q.; Schlenoff, J. B. The Polyelectrolyte Complex/Coacervate Continuum. Macromolecules 2014, 47 (9), 3108-3116. Here, the coacervate phase is being used as a casting solution, the PSS:PDADMAC ratio is close to 1.1:1. This could also explain why the 1.5/0.4 membrane properties are similar to the 55:45 membrane. Furthermore, it has been previously hypothesized that the demixing and excess of PDADMAC in the polymer-lean phase would lead to a chemical gradient potential that allows PDADMAC to diffuse to the surface thus resulting in overcompensation. The surface zeta potential for the 55:45 membrane is between +20 to +30 mV with varied pH values, where the 1.5/0.4 membrane is measured at +63 mV. The excess PDADMAC on the surface leads to a positive surface charge. However, excess PDADMAC is also known to make the complex rubbery, which would possibly compromise membrane long-term stability. Finally, the PWPs of the 50:50 and 55:45 membranes are significantly lower (<0.5 L m⁻² h⁻¹ bar⁻¹) than the 1.5/0.4 (3.9 L m⁻² h⁻¹ bar⁻¹) membranes, possibly resulting from a larger dry membrane thickness. In conclusion, the instantaneous demixing nature of the coacervate could create a more porous structure thus having higher PWP value.

Rejection of PEG as a function of molecular weight. Results of PEG rejection testing are shown in Table 2.

TABLE 2

| | PEG MW | | |
|---|---|---|---|
| Membrane | 2000 Da | 1000 Da | 600 Da |
| 1.5/0.4 | 54.1 ± 8.8 | 37.0 ± 3.6 | 13.6 ± 7.8 |
| Annealed | 34.5 ± 7.7 | 29.3 ± 6.9 | 6.7 ± 7.8 |
| Control | 89.4 ± 2.8 | 57.3 ± 7.0 | 49.7 ± 4.8 |

As shown in Table 2, the control showed the highest rejection over all three PEG molecules, while the annealed membrane had the lowest rejection. Previous studies have shown that the commercial PES 1 kDa control membrane demonstrated widespread rejections at its molecular weight cut-off (MWCO). With all membranes having an MWCO larger than 1 kDa, the 1.5/0.4 and annealed membranes fall into the tight-ultrafiltration category.

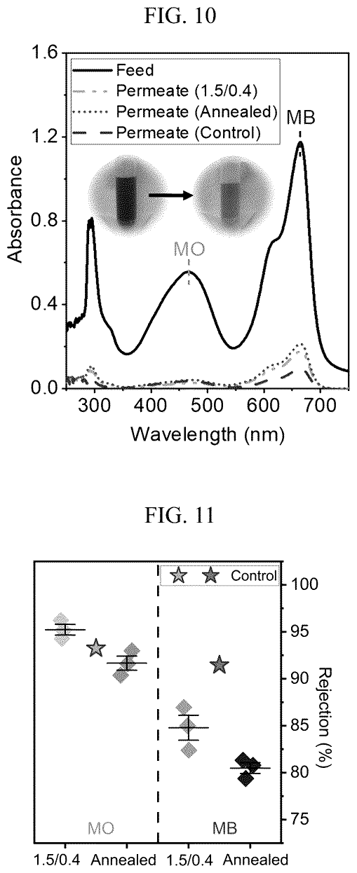

Dye Separation Performance of Coacervate Membranes. To characterize the separation capability of the present membranes, a solution containing both methylene blue (MB) and methyl orange (MO) was filtered through the as-prepared 1.5/0.4 membranes, as well as annealed and control membranes. These dyes were selected because they have opposite charges, yet similar molecular weight (M_{w}), MB is cationic with a M_{w}=320 g/mol, whereas MO is anionic with a M_{w}=327 g/mol. Since the molecular weight of both dyes is similar, it was expected that the separation would be dominated by electrostatic interactions instead of size-based sieving. FIG. 10 shows the UV-vis spectra of each of the dyes, as well as the feed and permeates of three tested membranes. The characteristic peak of MO at 465 nm is less visible than the peak of MB at 665 nm, showing higher retention and separation of anionic dye for all of the membranes. A closer look at dye rejection percentages for the tested samples is presented in FIG. 11. The MO rejection percentages for the 1.5/0.4, annealed and control membranes are 96.7, 96.7, and 86.7%, respectively, where the MB rejection percentages are 79.7, 74.5, and 89.6%, respectively. First, the MO rejection percentage of the PEC (1.5/0.4 and annealed) membrane is 10% higher than the control, whereas the MB rejection of the control is 9.9 and 15.1% higher than 1.5/0.4 and annealed. This is possibly due to the electrostatic interactions between the dyes and the membranes. As discussed in the next section, the positively charged PEC membranes would have higher adsorption over anionic dye than the negatively charged polyethersulfone control membranes, where the control membrane should have higher adsorption over cationic dye.

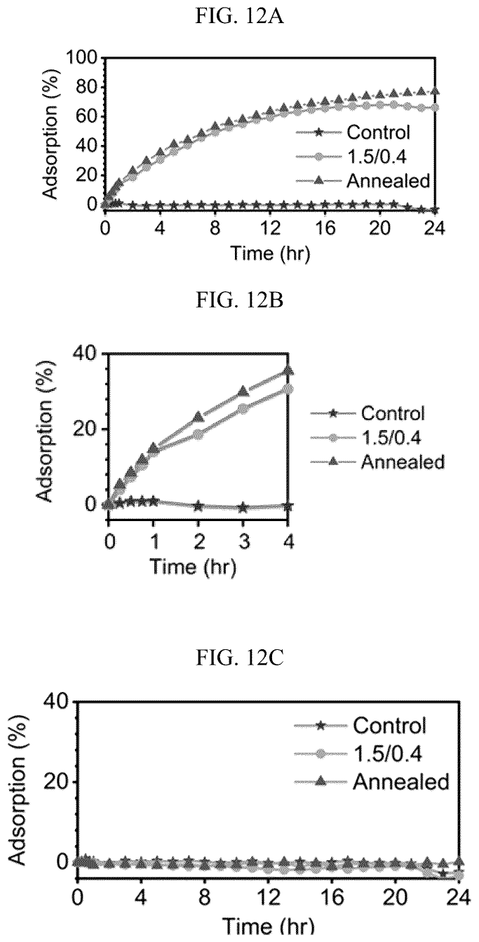

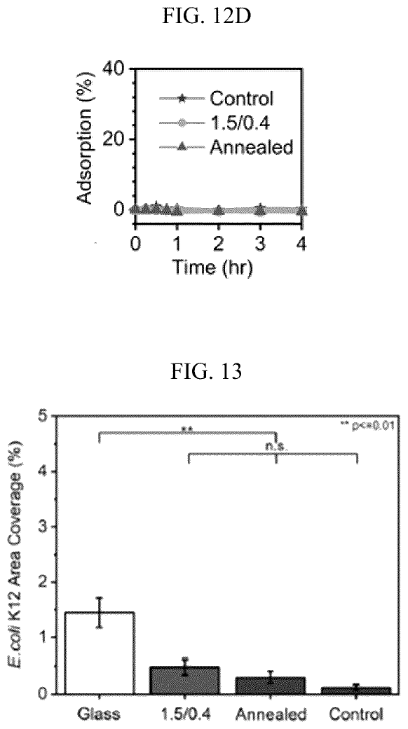

The electrostatic interaction was confirmed by the single-component adsorption results shown in FIG. 12. FIG. 12 (a) and (b) show that 1.5/0.4 and annealed membranes adsorbed 31% and 36% of MO in 4 h, and up to 67% and 78% after 24 h, respectively. Interestingly, all membranes showed negligible adsorption of MB even after 24 h. This may result from the control membrane having a negative surface potential at −40 mV, while PEC membranes had a positive surface potential at +63 mV. The control membrane showed a negligible amount of adsorption for both MO and MB, potentially, leading to the comparable rejection percentages achieved by the control for the two oppositely charged dyes. Finally, salt annealing showed a minimal effect on MO removal, suggesting a minor change to the surface charge, which is consistent with similar adsorption removal results for MO (FIG. 12(a)).

To further evaluate the performance of the PEC membranes, a solution containing 50 ppm each of MB and MO was filtered through the as-prepared 1.5/0.4, annealed, and control membranes. To eliminate the contribution of adsorption to dye rejection, membranes were immersed and saturated in feed solution for 24 h before steady-state dye separation tests. The characteristic peak of MO at 465 nm was less visible than that of MB at 665 nm, showing higher retention and separation of anionic dye for all membranes. The color of the PEC membranes turned from white to orange, whereas the control changed from white to green after 2 h of rejection tests, which again aligns with the observation after saturation adsorption. FIG. 12(c) shows a closer look at the tested samples' dye rejection percentages. The 1.5/0.4, annealed, and control membranes rejected 95.2, 91.7, and 93.2% MO, where 84.8, 80.5, and 91.4% MB was rejected, respectively. First, the MO and MB rejection decreased by 3.5% and 4.3% for membranes after annealing, respectively.

Antifouling Performance of Optimized PEC Membranes. The static antibiofouling properties of the 1.5/0.4, annealed, and control membranes were evaluated using E. coli using a process that is well established, and the results are shown in FIG. 13. In comparison to glass slides (control), the 1.5/0.4, annealed and control membranes all showed reduced E. coli adhesion from 1.45% to 0.48%, 0.30% and 0.12%, respectively. All membranes exhibited statistically lower fouling than the glass slides, showing great antibiofouling activity against E. coli. While the hydrophilicity and proximity of positive and negative charges within the polyelectrolyte complex likely prevent bacteria from adhering to the as-prepared membranes, polyethersulfone control membranes have been reported by the manufacturer to exhibit no hydrophobic or hydrophilic interactions and are usually preferred for their low fouling characteristics. The control membranes had a statistically equivalent area coverage by E. coli as both as-prepared and annealed membranes.

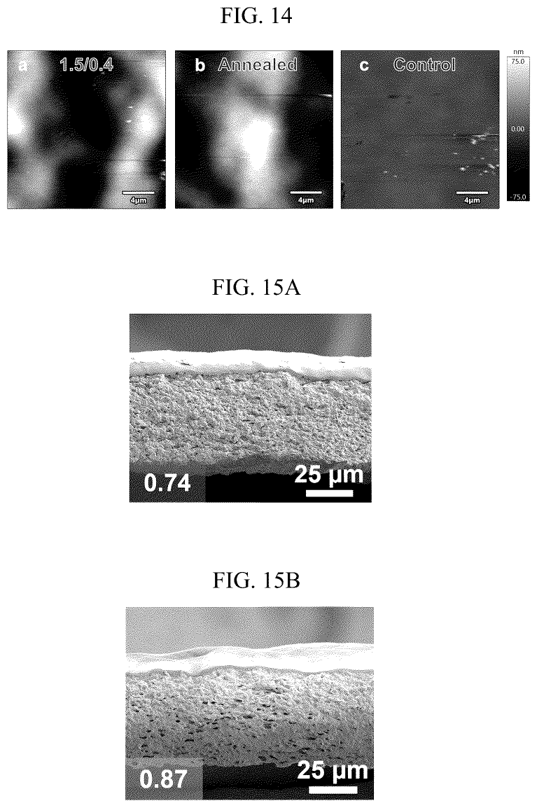

In addition to their difference in chemistry, the surface roughness of the membranes could also influence their propensity to foul. AFM roughness data and representative height profile images of 1.5/0.4, annealed and control membranes are summarized in FIG. 14. The control commercial membranes offer the lowest average surface roughness (Ra=nm) and a negatively charged surface, that is amenable to adhering the negatively charged E. coli cells. The average surface roughness (Ra=nm) of the 1.5/0.4 membrane was 42.4±14.8 nm and did not change significantly after annealing, which was determined to be 40.4±13.0 nm.

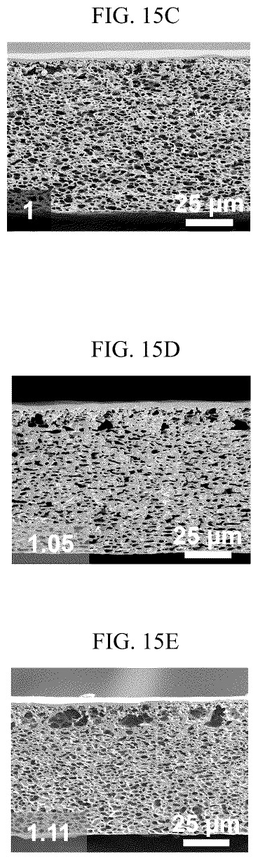

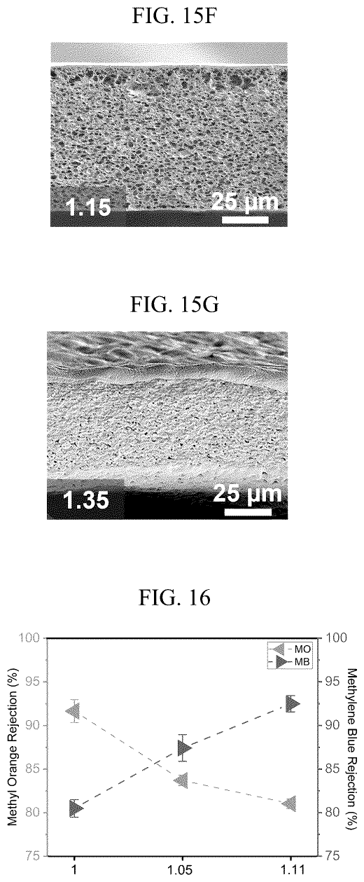

Effect of PSS/PDADMAC Stoichiometry. PSS/PDADMAC membranes were prepared at varying stoichiometric ratios of PSS/PDADMAC of 0.74, 0.87, 1.00, 1.05, 1.11, 1.15, and 1.35. FIG. 15A-G shows cross-sectional SEM images of the membranes. All seven PSS/PDADMAC membranes exhibited asymmetric morphologies, consistent with a dense skin layer overlying a more open porous substructure. SEM cross-sections revealed that the membranes prepared at ratios of 0.74, 0.87, 1.15, and 1.35 displayed a denser porous substructure, whereas those at 1.00, 1.05, and 1.11 exhibited a more open substructure. To further assess the off-stoichiometry membranes, solutions of MO and MB were passed through the membranes. FIG. 16 shows the rejection of anionic methyl orange (MA) and cationic methylene blue (MB) by PSS/PDADMAC membranes prepared at stoichiometric ratios of 1.00, 1.05, and 1.11.

Accordingly, the present inventors have successfully utilized the sustainable aqueous phase separation (APS) method to fabricate a mechanically stable PSS/PDADMAC complex membrane from a polymer-rich coacervate dope solution. The effect of salt annealing, coagulation bath salinity, and KBr concentration in the dope casting solution on membrane thickness, structure, and performance was systematically investigated. The pure water permeance value and rejection percent of the methyl orange and methylene blue dye molecules of the annealed membranes are comparable to commercial polyethersulfone nanofiltration membrane with a molecular weight cut off at 1000 Da. Furthermore, the antibiofouling performance toward E. coli was also demonstrated, for the first time, and repels bacteria at the same level as the commercial control membranes. A significant improvement is therefore provided by the present disclosure.

Hybrid materials comprising a combination of a natural polyelectrolyte and a synthetic polyelectrolyte were also examined. The following materials were used for the examples related to hybrid materials: carboxymethyl cellulose sodium salt powder (CMC, M_{w} 90,000 Da), potassium bromide (KBr, ACS Grade) and sodium chloride (NaCl, ACS Grade) that were purchased from Thermo Scientific. Poly(diallyl dimethyl ammonium) chloride aqueous solution (PDADMAC, 20 wt %, M_{w} 200,000-350,000 Da), deuterium oxide (D₂O), sodium hydroxide (NaOH), and hydrochloric acid were purchased from Sigma Aldrich. Deionized (DI) water was obtained from a Barnstead Nanopure Infinity water purification system (Thermo Fisher Scientific, Waltham, MA).

Preparation of Stock Solutions: Stock solutions of CMC and PDADMAC were prepared gravimetrically at 0.04M and 0.1M on a chargeable monomer basis, respectively. In the case of PDADMAC, a strong polyelectrolyte, the calculations were made assuming each repeat unit contains one single charge and thus, total concentration and molarity is based on repeat unit concentration. Calculations for molar concentration used a PDADMAC repeat unit molecular weight of 161.67 g/mol to determine the molarity of the as-received solutions (1.29M). Subsequent dilutions to 1.0M and 0.1M were completed using DI water (pH value=6) for final use.

CMC powder was used with a manufacturer reported degree of substitution (DS) of 0.7 charged units out of three possible per repeat unit; CMC aqueous solutions were prepared at 15.5 mg/mL in DI water (pH value=6) to an approximate charge concentration of 0.041M based on Equation 5:

$$Concentration of CMC = \frac{\frac{Molar Mass of CMC unit ( g )}{mol} \times \frac{0.04 mol}{L}}{Degree of Substitution ( D . S )} \qquad ( 5 )$$

Aqueous solutions of 5M NaCl and 4M KBr were prepared gravimetrically in DI water (pH value=6).

Fabrication of CMC/PDADMAC Coacervates: Complex coacervates were prepared by adding water and either NaCl or KBr solutions in a glass beaker at defined volumes and mixed on a stir plate. CMC and PDADMAC were added sequentially to the salt solution such that the total charged unit concentration of 0.04M and a total polymer concentration of 4.88 mg/mL while being mixed for 30 min to ensure a homogenous solution. Samples were next allowed to settle without agitation for 16 hr before the supernatant was removed; the dense coacervate phase was transferred to 50 mL Falcon tubes and centrifuged (Sorvall Legend Xlr Centrifuge, Thermo Fisher Scientific) at 2500 RPM for 10 min to complete the separation of the dense coacervate phase from the polymer-lean supernatant.

Characterization of CMC/PDADMAC Coacervates: Turbidity measurements were carried out on a microplate reader, (BioTek Synergy H1) at a wavelength of 562 nm. The previously described CMC, PDADMAC, and NaCl or KBr stock solutions were used to prepare coacervate samples with a total volume of 180 μL at a total charged monomer concentration of 0.01M. Immediately following sample preparation and mixing using a vortex mixer, 35 μL aliquots of each sample were pipetted into a 384-well plate. To measure the salt resistance of the coacervate phases and determine the optimal polyelectrolyte ratios for coacervate formation, experiments were conducted using salt-sweeps and stoichiometry-sweeps over salt ranges from 0-400 mM and cation/anion charge ratios from 0.27-22, respectively. After turbidimetric measurements, samples were inspected and imaged using Axiocam 503 Color Optical Microscope (Zeiss, Thornwood, NY) to confirm the presence or absence of complexation and whether samples contained liquid or solid complexes.

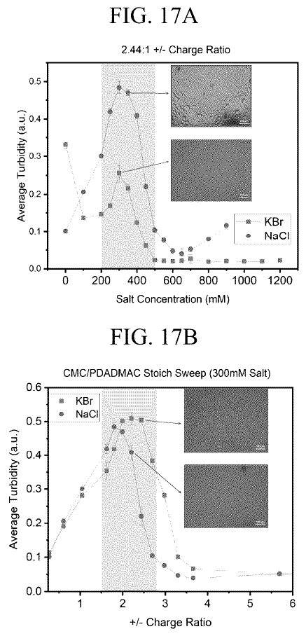

Turbidity results as a function of salt concentration and cation/anion molar charge ratio are shown in FIGS. 17A and 17B, respectively. The shaded range on both plots indicates variable ranges in which coacervates were observed via optical microscopy. Insets show optical micrographs depicting complex coacervate formations at 300 mM KBr and 310 mM NaCl at 2.22 and 2.44+/−charge ratio. Between 200 and 400 mM, at the turbidity peak and the trailing right edge, complex coacervates were observed as separated spheres in optical micrographs. Above 400 mM of either salt, a one-phase solution was observed. Coacervates were observed until 1:3 anion:cation in KBr samples and 1:2.67 in NaCl.

¹H-NMR was performed on as received CMC, dried as-received PDADMAC, coacervates, and films using a Bruker Avance III 400 MHz NMR. PDADMAC stock solution was cast on glass, air-dried in ambient conditions, and dried in a desiccator to prepare solid PDADMAC samples. Dried PDADMAC and CMC powder were both directly dissolved in 2.5M KBr in deuterium oxide (D₂O) at 10 mg/mL. Coacervate samples were frozen at −80° C. before being lyophilized to produce dried powders. Films were dried at 100° C. prior to 1H-NMR preparation. All samples were dissolved at 10 mg/mL in 2.5M KBr in D₂O and tested on ¹H-NMR run at 64 scans, data was analyzed using Bruker TopSpin software.

Fabrication of Free-Standing Membranes: Viscous coacervates (3-5 mL) were hand cast onto glass plates (17.8 cm×25.4 cm) using a casting knife (5.08×5.08 cm, Gardco Inc., Pompano Beach, FL) with a gate height of 40 mil (1.02 mm). After casting, the plates were submerged in a DI water coagulation bath at room temperature (22° C.) for 10 min to remove salt and precipitate solid membranes. The freshly cast membranes were next removed from their baths and allowed to fully dry in ambient conditions (22° C., 40-50% RH) for 6 hr. The edges of the films were then carefully released from the glass plates using a razor blade, which enabled the remaining membranes to be hand peeled thus creating free-standing membranes. Samples were stored at room temperature and ambient humidity.

CMC/PDADMAC Membranes Property Characterization: The fabricated membrane's surface morphology and cross-sectional structure were examined with scanning electron microscopy (SEM; FEI Magellan 400 XHR-SEM, ThermoFisher Scientific, Hillsboro, OR). Samples were sputter coated (Cressington 108 Sputter Coater, Watford, UK) with 6 nm of gold prior to imaging. Cross-sectional thickness of films were analyzed using ImageJ software for at least 10 locations on three different images.

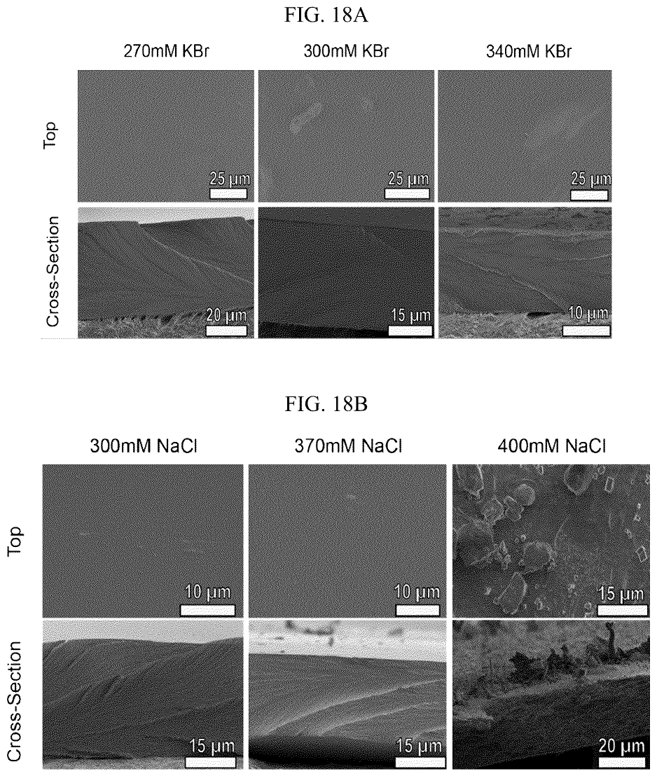

FIGS. 18A and 18B show SEM images of the films, including top-down and cross-sectional views at varying salt concentrations. In FIG. 18A, KBr-based CMC/PDADMAC membranes are shown to have consistently smooth top surfaces and show a dense cross-section. In FIG. 18B, NaCl-based CMC/PDADMAC membranes have the same consistently smooth surface and dense inner structure up to 370 mM. In the 400 mM NaCl film, salt crystals are observed . . . .

Mechanical properties of coacervate films were analyzed using a texture analyzer (TA, Stable Microsystems) equipped with mechanical grips. Film samples were cut using a razor blade into a dogbone shape (gauge width ˜7 mm, length ˜30 mm). Film thickness and width were measured using a Mitutoyo 293-330 digital micrometer (Toronto, Ontario, Canada). Tensile tests were conducted at a crosshead speed of 0.1 mm/s. Three replicates were completed for each film tested, with each sample coming from the same individual film.

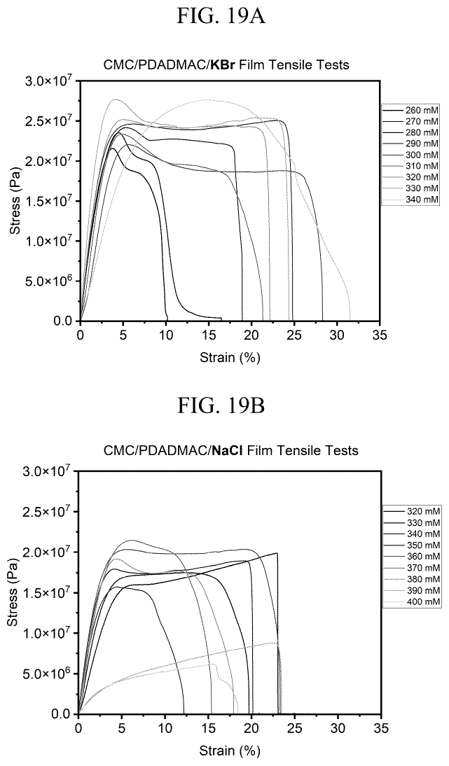

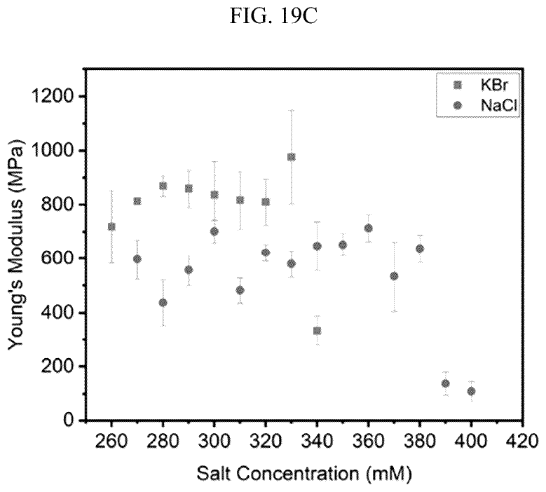

FIGS. 19A and 19B show tensile plots for CMC/PDADMAC films prepared across salt concentration ranges. FIG. 19C shows Young's Modulus of CMC/PDADMAC membranes as a function of salt type and salt concentration. In this example, CMC/PDADMAC membranes prepared with KBr reached higher Young's Modulus ranges compared to NaCl membranes. KBr-prepared membranes reached Young's Modulus values ranging from 718.5-975.7 MPa while NaCl-prepared films reached Young's Modulus values of 436.7-712.95 MPa. At salt resistance concentrations, the modulus of both KBr and NaCl membranes were 333.75 MPa and 109.37 to 137.65 MPa, respectively. KBr-prepared membranes exhibited UTS values ranging from 21.54-27.6 MPa while NaCl-prepared membranes had UTS values of 15.7-21.4 MPa. At salt resistance concentrations, the KBr membrane maintained high UTS (27.6 MPa), and the NaCl membranes had a UTS of 6.15-8.81 MPa.

This disclosure further encompasses the following aspects.

Aspect 1: A method for the manufacture of a polyelectrolyte coacervate membrane, the method comprising: providing a polyelectrolyte coacervate phase comprising a polyanion, a polycation, water, and a salt; coating the polyelectrolyte coacervate phase onto a substrate to provide a coated substrate; immersing the coated substrate in a coagulation bath to provide a polyelectrolyte coacervate membrane; and annealing the polyelectrolyte coacervate membrane to provide an annealed polyelectrolyte coacervate membrane.

Aspect 2: The method of aspect 1, further comprising removing salt from the polyelectrolyte coacervate membrane after immersing in the coagulation bath, removing salt from the annealed polyelectrolyte coacervate membrane, or both.

Aspect 3: The method of aspect 1 or 2, wherein the polyelectrolyte coacervate phase is made by a method comprising: providing an aqueous salt solution; sequentially adding the polyanion and the polycation to the aqueous salt solution; forming a homogenous solution; phase-separating the polyelectrolyte coacervate phase from an aqueous phase to provide the polyelectrolyte coacervate phase.

Aspect 4: The method of aspect 3, wherein the polyanion and the polycation are added to the aqueous salt solution in an amount effective to provide a 0.9:1.5 to 1.5:0.9, or 1.0:1.5 to 1.5:1.0, or 0.9:1.1 to 1.1:0.9, or 0.95:1.05 to 1.05:0.95, or a 1:1 molar ratio of anion monomer to cation monomer; or the polyanion and the polycation are added to the aqueous salt solution in an amount effective to provide a 1.25:1 to 1:3.20, or 1.20:1 to 1:2.60, or 1.10:1 to 1:2.10, or 1.05:1 to 0.95:1 molar ratio of anion monomer to cation monomer.

Aspect 5: The method of aspect 3 or 4, wherein the aqueous salt solution comprises salt in a concentration of 0.1 to 2 M, or 1.2 to 1.8 M, or 1.35 to 1.65 M, or 0.2 to 0.5 M, or 0.25 to 0.4 M; preferably wherein the salt comprises potassium bromide, sodium chloride, potassium chloride, sodium bromide, sodium thiocyanate, guanidinium bromide, guanidinium thiocyanate, or a combination thereof, preferably potassium bromide.

Aspect 6: The method of any of aspects 1 to 5, wherein the polyanion comprises poly(styrene sulfonate), poly(acrylic acid), poly(methacrylic acid), agar, alginate, hyaluronic acid, poly(phosphate), poly(vinyl sulfonic acid), poly(2-acrylamido-2-methylpropanesulfonate), carboxymethyl cellulose, or a combination thereof, preferably poly(styrene sulfonate) or carboxymethyl cellulose; and the polycation comprises poly(diallyldimethylammonium chloride), poly(allylamine), poly(ethylene imine), chitosan, poly(N-alkyl 4-vinyl pyridinium), poly(N-alkyl 2-vinyl pyridinium), poly([2-(acryloxy)ethyl]trimethylammonium chloride), poly(N,N-dimethyl-3,5-dimethylene piperidinium chloride), poly(vinylbenzyltrimethylammonium chloride), polyvinylamine, or a combination thereof, preferably poly(diallyldimethylammonium chloride).

Aspect 7: The method of any of aspects 1 to 6, wherein at least one of the polyanion or the polycation is a natural polymer.

Aspect 8: The method of aspect 7, wherein the polyanion is a natural polymer and the polycation is a synthetic polymer.

Aspect 9: The method of any of aspects 1 to 8, wherein the coagulation bath comprises salt in a concentration of 0 to 0.5 M, preferably 0.1 to 0.5 M, or 0.2 to 0.4 M, preferably wherein the salt comprises potassium bromide, sodium chloride, potassium chloride, sodium bromide, sodium thiocyanate, guanidinium bromide, guanidinium thiocyanate, or a combination thereof, preferably potassium bromide.

Aspect 10: The method of any of aspects 1 to 9, wherein annealing the polyelectrolyte coacervate membrane comprises thermal annealing, contacting with an ionic species, or a combination thereof.

Aspect 11: The method of any of aspects 1 to 10, wherein the annealing comprises salt annealing, preferably wherein the polyelectrolyte coacervate membrane is immersed in an aqueous medium comprising a salt capable of effecting a glass transition of the polyelectrolyte coacervate.

Aspect 12: The method of aspect 11, wherein the aqueous medium to anneal the polyelectrolyte coacervate membrane comprises a salt in a concentration of 1 to 2 M, preferably 1.2 to 2 M, preferably wherein the salt comprises sodium chloride.

Aspect 13: A polyelectrolyte coacervate membrane made by the method of any of aspects 1 to 12.

Aspect 14: The polyelectrolyte coacervate membrane of aspect 13, wherein the polyelectrolyte coacervate membrane is porous.

Aspect 15: The polyelectrolyte coacervate membrane of any of aspects 13 to 14, wherein the wet polyelectrolyte coacervate membrane has a thickness of 50 to 300 micrometers, preferably 50 to 150 micrometers.

Aspect 16: The polyelectrolyte coacervate membrane of any of aspects 13 to 15 comprising a dense skin layer and a porous layer.

Aspect 17: The polyelectrolyte coacervate membrane of aspect 16, wherein the dense skin layer has a thickness of 1 to 10 micrometers.

Aspect 18: The polyelectrolyte coacervate membrane of any of aspects 13 to 17, wherein the polyelectrolyte coacervate membrane has a pure water permeance of 1 to 10 L m⁻² h⁻¹ bar⁻¹.

Aspect 19: The polyelectrolyte coacervate membrane of any of aspects 13 to 18, wherein the polyelectrolyte coacervate membrane has a surface zeta potential of greater than −60 to +60 mV.

Aspect 20: The polyelectrolyte coacervate membrane of any of aspects 13 to 19, wherein the polyelectrolyte coacervate membrane exhibits reduced biofouling compared to glass.

Aspect 21: The polyelectrolyte coacervate membrane of any of aspects 13 to 20, wherein the polyelectrolyte coacervate membrane is capable of rejecting at least 90% of an anionic molecule having a molecular weight of less than 500 grams per mole.

Aspect 22: A method of purifying a liquid feed stream, the method comprising: passing the liquid feed stream through the polyelectrolyte coacervate membrane of any of aspects 13 to 21 or the polyelectrolyte coacervate membrane made by the method of any of aspects 1 to 12 to provide a purified liquid feed stream; wherein the liquid feed stream comprises at least one compound to be removed in a first concentration; and wherein the purified liquid feed stream comprising the compound to be removed in a second concentration that is less than the first concentration.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method for the manufacture of a polyelectrolyte coacervate membrane, the method comprising:
providing a polyelectrolyte coacervate phase comprising a polyanion, a polycation, water, and a salt;
coating the polyelectrolyte coacervate phase onto a substrate to provide a coated substrate;
immersing the coated substrate in a coagulation bath to provide a polyelectrolyte coacervate membrane; and
annealing the polyelectrolyte coacervate membrane to provide an annealed polyelectrolyte coacervate membrane.

2. The method of claim 1, further comprising removing salt from the polyelectrolyte coacervate membrane after immersing in the coagulation bath, removing salt from the annealed polyelectrolyte coacervate membrane, or both.

3. The method of claim 1, wherein the polyelectrolyte coacervate phase is made by a method comprising:
providing an aqueous salt solution;
sequentially adding the polyanion and the polycation to the aqueous salt solution;
forming a homogenous solution;
phase-separating the polyelectrolyte coacervate phase from an aqueous phase to provide the polyelectrolyte coacervate phase.

4. The method of claim 3, wherein
the polyanion and the polycation are added to the aqueous salt solution in an amount effective to provide a 0.9:1.5 to 1.5:0.9 molar ratio of anion monomer to cation monomer; or
the polyanion and the polycation are added to the aqueous salt solution in an amount effective to provide a 1.25:1 to 1:3.20 molar ratio of anion monomer to cation monomer.

5. The method of claim 3, wherein the aqueous salt solution comprises salt in a concentration of 0.1 to 2 M.

6. The method of claim 1, wherein
the polyanion comprises poly(styrene sulfonate), poly(acrylic acid), poly(methacrylic acid), agar, alginate, hyaluronic acid, poly(phosphate), poly(vinyl sulfonic acid), poly(2-acrylamido-2-methylpropanesulfonate), carboxymethyl cellulose, or a combination thereof; and
the polycation comprises poly(diallyldimethylammonium chloride), poly(allylamine), poly(ethylene imine), chitosan, poly(N-alkyl 4-vinyl pyridinium), poly(N-alkyl 2-vinyl pyridinium), poly([2-(acryloxy)ethyl]trimethylammonium chloride), poly(N,N-dimethyl-3,5-dimethylene piperidinium chloride), poly(vinylbenzyltrimethylammonium chloride), polyvinylamine, or a combination thereof.

7. The method of claim 1, wherein at least one of the polyanion or the polycation is a natural polymer.

8. The method of claim 7, wherein the polyanion is a natural polymer and the polycation is a synthetic polymer.

9. The method of claim 1, wherein the coagulation bath comprises salt in a concentration of 0 to 0.5 M.

10. The method of claim 1, wherein annealing the polyelectrolyte coacervate membrane comprises thermal annealing, contacting with an ionic species, or a combination thereof.

11. The method of claim 1, wherein the annealing comprises salt annealing, wherein the polyelectrolyte coacervate membrane is immersed in an aqueous medium comprising a salt capable of effecting a glass transition of the polyelectrolyte coacervate.

12. The method of claim 11, wherein the aqueous medium to anneal the polyelectrolyte coacervate membrane comprises a salt in a concentration of 1 to 2 M.

13. A polyelectrolyte coacervate membrane made by the method of claim 1.

14. The polyelectrolyte coacervate membrane of claim 13, wherein the polyelectrolyte coacervate membrane is porous.

15. The polyelectrolyte coacervate membrane of claim 13, wherein the polyelectrolyte coacervate membrane has a wet thickness of 50 to 300 micrometers.

16. The polyelectrolyte coacervate membrane of claim 13 comprising a dense skin layer and a porous layer.

17. The polyelectrolyte coacervate membrane of claim 16, wherein the dense skin layer has a thickness of 1 to 10 micrometers.

18. The polyelectrolyte coacervate membrane of claim 13, wherein the polyelectrolyte coacervate membrane
has a pure water permeance of 1 to 10 L m⁻² h⁻¹ bar⁻¹; or
has a surface zeta potential of greater than −60 to +60 mV; or
exhibits reduced biofouling compared to glass;
or a combination thereof.

19. The polyelectrolyte coacervate membrane of claim 13, wherein the polyelectrolyte coacervate membrane is capable of rejecting at least 90% of an anionic molecule having a molecular weight of less than 500 grams per mole.

20. A method of purifying a liquid feed stream, the method comprising:
passing the liquid feed stream through the polyelectrolyte coacervate membrane of claim 13 to provide a purified liquid feed stream;
wherein the liquid feed stream comprises at least one compound to be removed in a first concentration; and
wherein the purified liquid feed stream comprising the compound to be removed in a second concentration that is less than the first concentration.
